(19) United States
(12) Patent Application Publication
(10) Pub. No.: US 2026/0187569 A1
(43) Pub. Date: Jul. 2, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventor: Riki ETO, Tokyo (JP)

(73) Assignee: NEC Corporation, Tokyo (JP)

(21) Appl. No.: 19/407,245

(22) Filed: Dec. 3, 2025

(30) Foreign Application Priority Data
Dec. 26, 2024 (JP) 2024-230812

(51) Int. Cl. G06Q 10/0639; G06Q 10/04

(52) U.S. Cl. CPC G06Q 10/0639; G06Q 10/04

(57) ABSTRACT

An information processing apparatus includes an acquisition unit for obtaining target data, a designation unit for designating one or a plurality of explanatory variables and one or a plurality of target variables from a plurality of features included in the target data, and a derivation unit for deriving a first linear combination of the one or plurality of explanatory variables, the first linear combination defining an upper limit of the target variable, and a second linear combination of the one or plurality of explanatory variables, the second linear combination defining a lower limit of the target variable.

This application is based upon and claims the benefit of priority from Japanese Patent Application No. 2024-230812, filed on Dec. 26, 2024, the disclosure of which is incorporated herein in its entirety by reference.

### TECHNICAL FIELD

The present disclosure relates to an information processing apparatus, an information processing system, an information processing method, and a recording medium.

### BACKGROUND ART

Techniques related to upper and lower limits of data have been known. For example, JP 2021-56671 A discloses a production support system that resets product quality to an acceptable range satisfying predetermined quality if an element value related to a factor of production of a product exceeds the acceptable range.

### SUMMARY

In the production support system disclosed in JP 2021-56671 A, no acceptable range is assumed for a case where there is a plurality of factors of production. In other words, in the production support system disclosed in JP 2021-56671 A, setting the acceptable range of the element value from the factor of production including a plurality of features is not assumed. Meanwhile, in the field of business optimization and the like, there is a realistic need to appropriately set or detect upper and lower limits from data including a plurality of features.

The present disclosure has been conceived in view of the problem described above, and an exemplary object thereof is to provide a technique of setting appropriate upper and lower limits for data including a plurality of features.

An information processing apparatus according to an exemplary aspect of the present disclosure includes an acquisition means for obtaining target data including a plurality of features, a designation means for designating one or a plurality of explanatory variables and one or a plurality of target variables from the plurality of features included in the target data, and a derivation means for deriving a first linear combination of the one or plurality of explanatory variables, the first linear combination defining an upper limit of the target variable, and a second linear combination of the one or plurality of explanatory variables, the second linear combination defining a lower limit of the target variable.

An information processing method according to an exemplary aspect of the present disclosure includes acquisition processing in which at least one processor obtains target data including a plurality of features, designation processing in which the at least one processor designates one or a plurality of explanatory variables and one or a plurality of target variables from the plurality of features included in the target data, and derivation processing in which the at least one processor derives a first linear combination of the one or plurality of explanatory variables, the first linear combination defining an upper limit of the target variable, and a second linear combination of the one or plurality of explanatory variables, the second linear combination defining a lower limit of the target variable.

An information processing program according to an exemplary aspect of the present disclosure is a program for causing a computer to function as an information processing apparatus, and the program causes the computer to function as an acquisition means for obtaining target data including a plurality of features, a designation means for designating one or a plurality of explanatory variables and one or a plurality of target variables from the plurality of features included in the target data, and a derivation means for deriving a first linear combination of the one or plurality of explanatory variables, the first linear combination defining an upper limit of the target variable, and a second linear combination of the one or plurality of explanatory variables, the second linear combination defining a lower limit of the target variable.

According to an exemplary aspect of the present disclosure, an exemplary effect is exerted in which a technique of setting appropriate upper and lower limits for data including a plurality of features may be provided.

### BRIEF DESCRIPTION OF THE DRAWINGS

Exemplary features and advantages of the present disclosure will become apparent from the following detailed description if taken with the accompanying drawings in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a block diagram illustrating a configuration of the information processing system according to the present disclosure;

FIG. 5 is a diagram schematically illustrating an output of each end point model in an LPV model according to the present disclosure and an internal division ratio parameter by which each output is multiplied;

FIG. 6 is a diagram illustrating an exemplary processing flow of the information processing apparatus according to the present disclosure;

FIG. 7 illustrates an exemplary graph displayed by an output unit according to the present disclosure via an input/output unit;

FIG. 8 is a diagram illustrating another exemplary processing flow of the information processing apparatus according to the present disclosure;

FIG. 9 is a diagram illustrating an example of a graph displayed by the output unit via the input/output unit and explanatory information displayed by a generation unit via the input/output unit according to the present disclosure;

FIG. 10 is a block diagram illustrating a configuration of the information processing system according to the present disclosure; and

FIG. 11 is a block diagram illustrating a configuration of a computer that functions as the information processing apparatus, a first information processing apparatus, a second information processing apparatus, and an optimization device according to the present disclosure.

### EXAMPLE EMBODIMENT

Hereinafter, example embodiments of the present disclosure will be exemplified. However, the present disclosure is not limited to the following illustrative example embodiments, and various modifications may be made within the scope described in the claims. For example, example embodiments obtained by appropriately combining techniques (some or all of objects or methods) adopted in the following illustrative example embodiments may also fall within the scope of the present disclosure. Example embodiments obtained by appropriately omitting some of the techniques adopted in the following illustrative example embodiments may also fall within the scope of the present disclosure. Effects mentioned in the following illustrative example embodiments are examples of effects expected in the illustrative example embodiments, and do not define extension of the present disclosure. That is, example embodiments that do not exert the effects mentioned in the following illustrative example embodiments may also fall within the scope of the present disclosure.

### First Example Embodiment

A first example embodiment, which is an example of the example embodiments of the present disclosure, will be described in detail with reference to the drawings. The present example embodiment is a basic form of the individual example embodiments to be described below. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### (Configuration of Information Processing Apparatus 1)

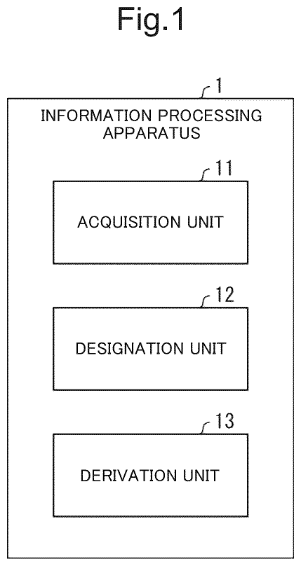

A configuration of an information processing apparatus 1 will be described with reference to FIG. 1. FIG. 1 is a block diagram illustrating the configuration of the information processing apparatus 1. As illustrated in FIG. 1, the information processing apparatus 1 includes an acquisition unit 11, a designation unit 12, and a derivation unit 13. In the present example embodiment, the acquisition unit 11, the designation unit 12, and the derivation unit 13 implement an acquisition means, a designation means, and a derivation means, respectively.

### (Acquisition Unit 11)

The acquisition unit 11 obtains target data including a plurality of features. The acquisition unit 11 supplies the obtained target data to the designation unit 12 and to the derivation unit 13.

### (Designation Unit 12)

The designation unit 12 designates, from the plurality of features included in the target data, one or a plurality of explanatory variables and one or a plurality of target variables. The designation unit 12 supplies, to the derivation unit 13, information indicating the designated one or plurality of explanatory variables and one or plurality of target variables.

### (Derivation Unit 13)

The derivation unit 13 derives a first linear combination of the one or plurality of explanatory variables, that is, a first linear combination that defines an upper limit of the target variable, and a second linear combination of the one or plurality of explanatory variables, that is, a second linear combination that defines a lower limit of the target variable.

The derivation unit 13 trains a plurality of individual regression models associated with a plurality of individual ratio parameters defined by a hidden variable with reference to at least a part of the target data, and derives the first linear combination and the second linear combination using the plurality of regression models.

### (Effects of Information Processing Apparatus 1)

As described above, the information processing apparatus 1 employs the configuration including the acquisition unit 11 that obtains the target data including the plurality of features, the designation unit 12 that designates the one or plurality of explanatory variables and one or plurality of target variables from the plurality of features included in the target data, and the derivation unit 13 that derives the first linear combination of the one or plurality of explanatory variables, that is, the first linear combination that defines the upper limit of the target variable, and the second linear combination of the one or plurality of explanatory variables, that is, the second linear combination that defines the lower limit of the target variable.

Thus, according to the information processing apparatus 1, an effect may be obtained in which appropriate upper and lower limits may be set for data including a plurality of features.

### (Flow of Information Processing Method S1)

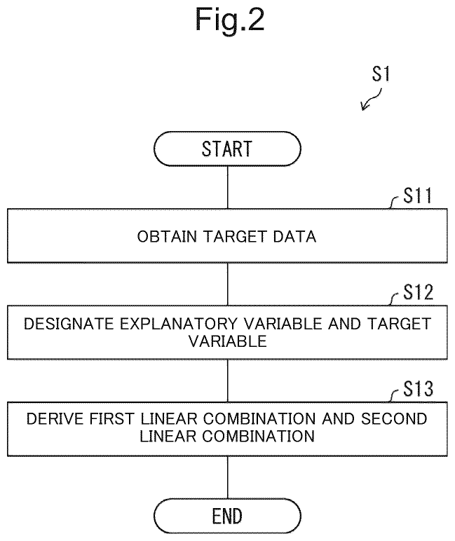

A flow of an information processing method S1 will be described with reference to FIG. 2. FIG. 2 is a flowchart illustrating the flow of the information processing method S1. As illustrated in FIG. 2, the information processing method S1 includes acquisition processing S11, designation processing S12, and derivation processing S13.

### (Acquisition Processing S11)

In the acquisition processing S11, the acquisition unit 11 obtains the target data including the plurality of features.

The acquisition unit 11 supplies the obtained target data to the designation unit 12 and to the derivation unit 13.

### (Designation Processing S12)

In the designation processing S12, the designation unit 12 designates, from the plurality of features included in the target data, one or a plurality of explanatory variables and one or a plurality of target variables. The designation unit 12 supplies, to the derivation unit 13, information indicating the designated one or plurality of explanatory variables and one or plurality of target variables.

### (Derivation Processing S13)

In the derivation processing S13, the derivation unit 13 derives the first linear combination of the one or plurality of explanatory variables, that is, the first linear combination that defines the upper limit of the target variable, and the second linear combination of the one or plurality of explanatory variables, that is, the second linear combination that defines the lower limit of the target variable.

### (Effects of Information Processing Method S1)

As described above, the information processing method S1 employs the configuration including the acquisition processing S11 in which the acquisition unit 11 obtains the target data including the plurality of features, the designation processing S12 in which the designation unit 12 designates the one or plurality of explanatory variables and one or plurality of target variables from the plurality of features included in the target data, and the derivation processing S13 in which the derivation unit 13 derives the first linear combination of the one or plurality of explanatory variables, that is, the first linear combination that defines the upper limit of the target variable, and the second linear combination of the one or plurality of explanatory variables, that is, the second linear combination that defines the lower limit of the target variable. Thus, according to the information processing method S1, an effect similar to that of the information processing apparatus 1 described above may be obtained.

### (Configuration of Information Processing System 100)

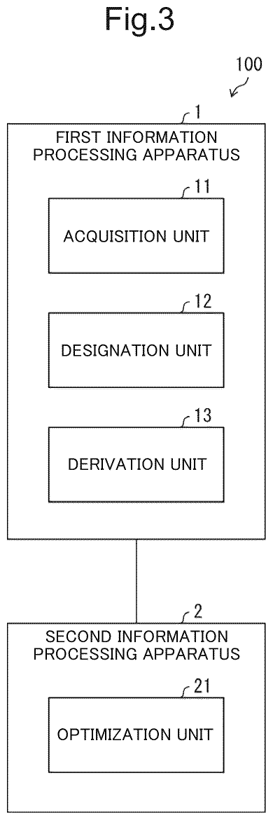

A configuration of an information processing system 100 will be described with reference to FIG. 3. FIG. 3 is a block diagram illustrating the configuration of the information processing system 100. As illustrated in FIG. 3, the information processing system 100 includes a first information processing apparatus 1 and a second information processing apparatus 2.

### (First Information Processing Apparatus 1)

As illustrated in FIG. 3, the first information processing apparatus 1 includes the acquisition unit 11, the designation unit 12, and the derivation unit 13. In the present example embodiment, the acquisition unit 11, the designation unit 12, and the derivation unit 13 implement an acquisition means, a designation means, and a derivation means, respectively.

### (Acquisition Unit 11)

The acquisition unit 11 obtains target data including a plurality of features. The acquisition unit 11 supplies the obtained target data to the designation unit 12 and to the derivation unit 13.

### (Designation Unit 12)

The designation unit 12 designates, from the plurality of features included in the target data, one or a plurality of explanatory variables and one or a plurality of target variables. The designation unit 12 supplies, to the derivation unit 13, information indicating the designated one or plurality of explanatory variables and one or plurality of target variables.

### (Derivation Unit 13)

The derivation unit 13 derives a first linear combination of the one or plurality of explanatory variables, that is, a first linear combination that defines an upper limit of the target variable, and a second linear combination of the one or plurality of explanatory variables, that is, a second linear combination that defines a lower limit of the target variable.

### (Second Information Processing Apparatus 2)

As illustrated in FIG. 3, the second information processing apparatus 2 includes an optimization unit 21. In the present example embodiment, the optimization unit 21 implements an optimization means.

### (Optimization Unit 21)

The optimization unit 21 executes optimization processing with reference to at least a part of the target data under a constraint condition defined using at least one of the first linear combination and the second linear combination.

### (Effects of Information Processing System 100)

As described above, in the information processing system 100, the configuration including the first information processing apparatus 1 and the second information processing apparatus 2 is adopted.

The first information processing apparatus 1 employs the configuration including the acquisition unit 11 that obtains the target data including the plurality of features, the designation unit 12 that designates the one or plurality of explanatory variables and one or plurality of target variables from the plurality of features included in the target data, and the derivation unit 13 that derives the first linear combination of the one or plurality of explanatory variables, that is, the first linear combination that defines the upper limit of the target variable, and the second linear combination of the one or plurality of explanatory variables, that is, the second linear combination that defines the lower limit of the target variable.

The second information processing apparatus 2 employs the configuration including the optimization unit 21 that executes the optimization processing with reference to at least a part of the target data under the constraint condition defined using at least one of the first linear combination and the second linear combination.

Thus, according to the information processing system 100, an effect similar to that of the information processing apparatus 1 described above may be obtained.

### Second Example Embodiment

A second example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### (Configuration and Outline of Information Processing System 100A)

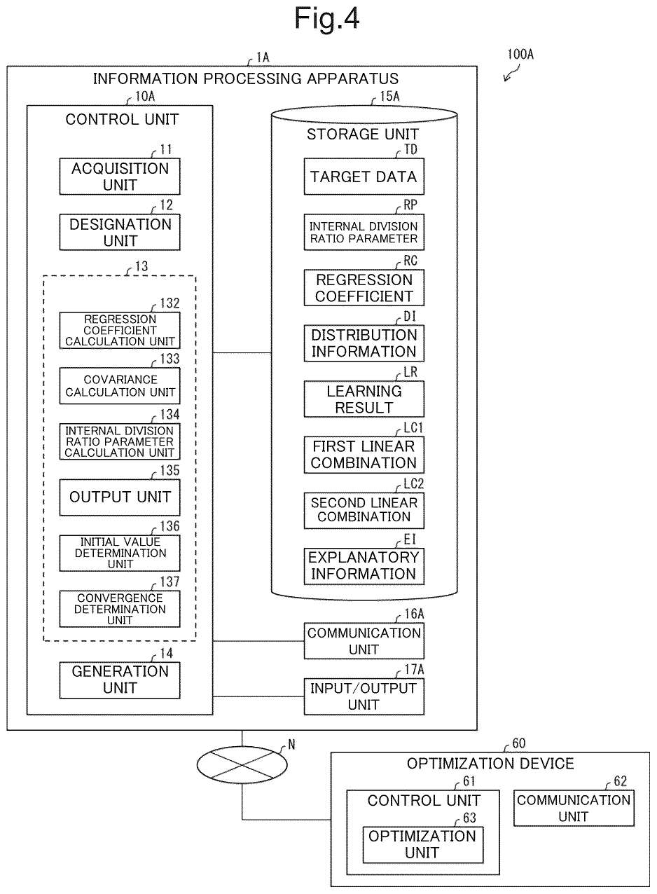

An outline of an information processing system 100A will be described with reference to FIG. 4. FIG. 4 is a block diagram illustrating a configuration of the information processing system 100A. As illustrated in FIG. 4, the information processing system 100A includes an information processing apparatus 1A and an optimization device 60.

In the information processing system 100A, the information processing apparatus 1A and the optimization device 60 are communicably connected. As an example, as illustrated in FIG. 4, the information processing apparatus 1A and the optimization device 60 are communicably connected via a network N. While a specific configuration of the network N is not particularly limited, as an example, a wireless local area network (LAN), a wired LAN, a wide area network (WAN), a public line network, a mobile data communication network, or a combination of those networks may be used.

In the information processing system 100A, the information processing apparatus 1A designates one or a plurality of explanatory variables and one or a plurality of target variables from a plurality of features included in target data TD. Then, the information processing apparatus 1A derives a first linear combination LC1 of the one or plurality of explanatory variables, that is, a linear combination LC1 that defines an upper limit of the target variable. The information processing apparatus 1A further derives a second linear combination LC2 of the one or plurality of explanatory variables, that is, a second linear combination LC2 that defines a lower limit of the target variable. Then, the information processing apparatus 1A outputs the derived first linear combination LC1 and second linear combination LC2 to the optimization device 60.

In the information processing system 100A, the optimization device 60 executes optimization processing with reference to at least a part of the target data TD under a constraint condition defined using at least one of the first linear combination LC1 and the second linear combination LC2 output from the information processing apparatus 1A.

As an example, the information processing apparatus 1A obtains, as the target data TD, log data (e.g., time during which a worker A has performed tasks X and Y, time during which a worker B has performed tasks X and Z, etc.) of each of a plurality of tasks performed by a plurality of workers. Then, the information processing apparatus 1A outputs, to the optimization device 60, the first linear combination LC1 indicating an upper limit working time and the second linear combination LC2 indicating a lower limit working time for each combination of the worker and the task.

Upon acquisition of the first linear combination LC1 indicating the upper limit working time and the second linear combination LC2 indicating the lower limit working time from the information processing apparatus 1A for each combination of the worker and the task, the optimization device 60 executes the optimization processing of the combination of the worker and the working time. For example, the optimization device 60 determines the combination of the worker and the working time for performing a predetermined task in such a way that the predetermined task is complete within a predetermined time.

In the information processing system 100A, the optimization processing may be executed under a constraint condition.

As an example, the optimization device 60 may execute the optimization processing with reference to at least a part of the target data TD under the constraint condition defined using at least one of the first linear combination LC1 and the second linear combination LC2.

As another example, the optimization device 60 may execute the optimization processing with reference to at least a part of the target data TD under no constraint condition. In that case, if a combinatorial explosion occurs in the optimization processing by the optimization device 60 (if no solution is obtained), the optimization device 60 may derive a constraint condition and execute the optimization processing under the constraint condition.

### (Exemplary Processing Algorithm Used in Information Processing System 100A)

An exemplary processing algorithm to be used in the information processing system 100A according to the present example embodiment will be described. The present inventor is advancing the study of a linear parameter-varying (LPV) model as modeling of a system with variations. As an example, in the LPV model, an internal state quantity (internal state variable) xₖ and an output state quantity (output state variable) yₖ are updated and calculated by the following formulae (1A) and (1).

$$\\ \begin{matrix}[ Math . 1 ] & \\ {x}_{k + 1} = {{\sum }_{i = 1}}^{m} {μ}_{k}^{( i )} ( {A}^{( i )} {x}_{k} + {B}^{( i )} {u}_{k} ) & ( 1 A )\end{matrix}$$

$$\\ \begin{matrix}{y}_{k} = {Cx}_{k} + {Du}_{k} & ( 1 B )\end{matrix}$$

Here, A⁽ⁱ⁾ and B⁽ⁱ⁾ represent matrices that express state space models (which are also referred to as end point models) identified by an index i, and μ⁽ⁱ⁾k represents a parameter that defines an internal division ratio (weight) of each model. The parameter μ⁽ⁱ⁾k is referred to as an internal division ratio parameter, a weight parameter, or a scheduling parameter. In the LPV model described above, as an example, uₖ represents an input quantity (input variable), and C and D represent output matrices calculated based on xₖ and uₖ, respectively. An index assigned to each state variable is represented by k, which represents, for example, time.

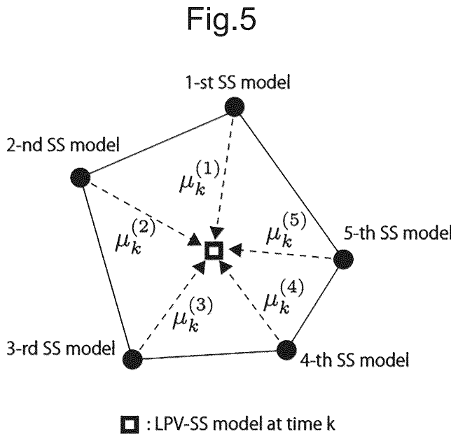

FIG. 5 is a diagram schematically illustrating an output of each end point model (1-st SS model to 5-th SS model in FIG. 5) in the LPV model described above and the internal division ratio parameter μ⁽ⁱ⁾k by which each output is multiplied. As illustrated in FIG. 5, the outputs of the plurality of individual end point models at the k-th step

(A⁽ⁱ⁾xₖ+B⁽ⁱ⁾uₖ) (i=1 to 5) are multiplied by the internal division ratio parameters μ⁽ⁱ⁾ₖ (i=1 to 5), whereby xₖ₊₁ at the (k+1)-th step is calculated.

While such an LPV model has an aspect that it is suitable for modeling of a system with variations, there has been a problem that it is difficult to apply the LPV model to a system in which a value of the internal division ratio parameter μ⁽ⁱ⁾ₖ is not clear.

The present inventor has found that, even if the internal division ratio parameter is unknown, the LPV model may be trained as follows: —the internal division ratio parameter μ⁽ⁱ⁾ₖ described above is treated as (posterior probability of) a hidden variable zₖ; —a training method of a hidden variable model in machine learning is applied; and—the internal division ratio parameter μ⁽ⁱ⁾ₖ described above is calculated as an expected value of the hidden variable zₖ. More specifically, the present inventor has conceived the idea of rewriting a latent linear parameter-varying (L2PV) model defined by the following formulae (2A) to (2C) in which the internal division ratio parameter μ⁽ⁱ⁾ₖ is introduced as a hidden variable

$$\\ \begin{matrix}[ Math . 2 ] & \\ {x}_{k + 1} = {{\sum }_{i = 1}}^{m} {μ}_{k}^{( i )} ( {A}^{( i )} {x}_{k} + {B}^{( i )} {u}_{k} ) + {w}_{k} , & ( 2 A )\end{matrix}$$

$$\\ \begin{matrix}{y}_{k} = {Cx}_{k} + {Du}_{k} + {v}_{k} , & ( 2 B )\end{matrix}$$

$$\\ \begin{matrix}0 \leq {μ}_{k}^{( i )} \leq 1 , {{\sum }_{i = 1}}^{m} {μ}_{k}^{( i )} = 1 , & ( 2 C )\end{matrix}$$

as a regression model format (L2PV regression model) defined by the following formulae (3A) to (3E)

$$\\ \begin{matrix}[ Math . 3 ] & \\ {\tilde{y}}_{k} = {{\sum }_{i = 1}}^{m} {μ}_{k}^{( i )} {W}^{( i )} {\tilde{x}}_{k} + {ϵ}_{k} where , & ( 3 A )\end{matrix}$$

$$\\ \{ \begin{matrix}{\tilde{y}}_{k} := {y}_{k + 1} ∈ {ℝ}^{r} & ( 3 B ) \\ {\tilde{x}}_{k} := [ \begin{matrix}{x}_{k} \\ {u}_{k}\end{matrix} ] ∈ {ℝ}^{l} & ( 3 C ) \\ {W}^{( i )} := [ \begin{matrix}{CA}^{( i )} & {CB}^{( i )}\end{matrix} ] & ( 3 D ) \\ D = 0 & ( 3 E )\end{matrix}$$

in such a way that the internal division ratio parameter μ⁽ⁱ⁾ₖ is set as a training target.

A process in the information processing system 100A to be described below is based on the formulation described above, and is a process based on the unique perspective of the present inventor.

### (Configuration of Information Processing Apparatus 1A)

A configuration of the information processing apparatus 1A will be described with reference to FIG. 4 again. As illustrated in FIG. 4, the information processing apparatus 1A includes a control unit 10A, a storage unit 15A, a communication unit 16A, and an input/output unit 17A.

### (Storage Unit 15A)

First, various types of data (information) stored in the storage unit 15A will be described. The storage unit 15A stores data to be referred to by the control unit 10A. Examples of the storage unit 15A include, but are not limited to, a flash memory, a hard disk drive (HDD), a solid state drive (SSD), and a combination thereof.

As illustrated in FIG. 4, examples of the data stored in the storage unit 15A include, but are not limited to, the target data TD, an internal division ratio parameter RP, a regression coefficient RC, distribution information DI, a learning result LR, the first linear combination LC1, the second linear combination LC2, and explanatory information EI.

The target data TD includes a plurality of features, and is used for training processing in the information processing apparatus 1A. The target data TD is expressed as the following formula (4) as a set of the state variable (˜xₖ) and the state variable (˜yₖ). In the present specification, the state variables xₖ, ˜xₖ, yₖ, and ˜yₖ may be referred to as features. The state variables xₖ and ˜xₖ may be referred to as explanatory variables, and the state variables yₖ and ˜yₖ may be referred to as target variables. In a case where the target variable is a derivation target, the target variable may be referred to as a prediction value. Those specific designations do not limit the content described in the present specification.

$$\\ \begin{matrix}[ Math . 4 ] & \\ {\{ {\tilde{x}}_{k} , {\tilde{y}}_{k} \}}_{k = 1}^{N} & ( 4 )\end{matrix}$$

The internal division ratio parameter RP is a parameter that defines a relative weight of the plurality of state space models in the LPV model, and is also referred to as a scheduling parameter. The internal division ratio parameter RP is also referred to as a weight parameter RP, or a scheduling parameter RP. As an example, the internal division ratio parameter RP is given by the following formula (5) associated to each of m models (models 1 to m).

$$\begin{matrix}[ Math . 5 ] & \\ {\{ {μ}_{k} \}}_{k = 1}^{N} & ( 5 )\end{matrix}$$

Here, k represents an index similar to the index assigned to each state variable described above, and N represents a dimension of each state variable (number of samples of each state variable). In the formula mentioned above, the index (i) related to the model is not explicitly expressed. This may be interpreted that the internal division ratio parameter RP described above is expressed as, for each k, an internal division ratio parameter vector including components associated to the models 1 to m as follows.

μₖ=(μₖ⁽¹⁾, μₖ⁽²⁾, . . . , k^{(m)}) As described above, the internal division ratio parameter RP may be expressed as an internal division ratio parameter vector, or may be expressed as an internal division ratio parameter matrix. As an example, a case of m=2 will be described in the present disclosure.

An internal division ratio parameter μₖ^{(j)} related to a certain model j may also be expressed as a component of an N-dimensional vector having components associated to the N-dimensional target data xₖ (k=1 to N). More specifically, the j-th internal division ratio parameter μₖ^{(j)} is a component of the N-dimensional vector having components (μ₁^{(j)}), μ₂^{(j)}, . . . , μ_{N}^{(j)}) associated to the N-dimensional target data xₖ (k=1 to N).

In the present disclosure, it is not limited to the internal division ratio parameter RP, and may be an external division ratio parameter.

Hereinafter, the internal division ratio parameter RP may also be referred to as a ratio parameter RP.

The regression coefficient RC is a coefficient in the L2PV regression model.

The regression coefficient RC is expressed by the following formula (6).

$$\begin{matrix}[ Math . 6 ] & \\ W = [ {W}^{( 1 )} , … , {W}^{( m )} ] & ( 6 )\end{matrix}$$

The distribution information DI includes a covariance matrix Φ of a prior distribution of the hidden variable, a covariance parameter η of the prior distribution of the hidden variable, and a covariance parameter Ψ of a posterior distribution of the hidden variable.

A prior distribution p(zₖ) of the hidden variable zₖ is expressed by the following formula (7).

$$\begin{matrix}[ Math . 7 ] & \\ p ( {z}_{k} ) = 𝒩 ( {z}_{k} \vert \frac{1}{m} {1}_{m , 1} , Φ ) & ( 7 )\end{matrix}$$

In other words, the covariance parameter η of the prior distribution of the hidden variable zₖ is the covariance parameter η of a model likelihood p(˜yₖ|zₖ, ˜xₖ, W, η) expressed by the following formula (8).

$$\begin{matrix}[ Math . 8 ] & \\ μ ( {\tilde{y} \vert}_{k} {z}_{k} , {\tilde{x}}_{k} , W , η ) = 𝒩 ( {\tilde{y} \vert}_{k} {{\sum }_{i = 1}}^{m} {z}_{k}^{( i )} {W}^{( i )} {\tilde{x}}_{k} {η}^{- 1} {I}_{r} ) & ( 8 )\end{matrix}$$

A posterior distribution p(zₖ|˜yₖ, ˜xₖ, W, η) of the hidden variable zₖ is expressed by the following formula (9).

$$\begin{matrix}[ Math . 9 ] & \\ p ( {z}_{k} \vert {\tilde{y} ,}_{k} {\tilde{x} ,}_{k} W , η ) = 𝒩 ( {z}_{k} \vert {μ}_{k} , {Ψ}_{k} ) & ( 9 )\end{matrix}$$

In the formula mentioned above, N in the calligraphy font on the right side represents a normal distribution. However, this does not mean that the exemplary distribution in the present example embodiment is limited to the normal distribution. As an example, a Dirichlet distribution may be used as the posterior distribution of the hidden variable zₖ.

As will be described later, in the processing by the information processing apparatus 1A, the posterior distribution p(zₖ|˜yₖ, ˜xₖ, W, η) of the hidden variable zₖ is expressed under a restraint condition (constraint condition) of the following formula (10).

$$\begin{matrix}[ Math . 10 ] & \\ 0 \leq {μ}_{k}^{( i )} \leq 1 , {\sum }_{i = 1}^{m} {μ}_{k}^{( i )} = 1 & ( 10 )\end{matrix}$$

Thus, even if the normal distribution is used as the posterior distribution of the hidden variable zₖ, suitable calculation may be executed.

The learning result LR includes the calculated internal division ratio parameter RP and the calculated regression coefficient RC.

The first linear combination LC1 is a linear combination specified by the regression coefficient RC associated to the internal division ratio parameter μₖ⁽¹⁾ related to the model 1. In other words, the first linear combination LC1 is a linear combination of one or a plurality of explanatory variables, that is, a linear combination that defines the upper limit of the target variable. If the target variable is y and the explanatory variable is f={f₁, f₂, . . . }, the first linear combination LC1 is expressed by the following formula (11).

$$\begin{matrix}[ Math . 11 ] & \\ y = {a}^{T} f + b & ( 11 )\end{matrix}$$

The second linear combination LC2 is a linear combination specified by the regression coefficient RC associated to the internal division ratio parameter μₖ⁽²⁾ related to the model 2. In other words, the second linear combination LC2 is a linear combination of the one or plurality of explanatory variables, that is, a linear combination that defines the lower limit of the target variable. If the target variable is y and the explanatory variable is f={f₁, f₂, . . . }, the second linear combination LC2 is expressed by the following formula (12).

$$\begin{matrix}[ Math . 12 ] & \\ y = {c}^{T} f + d & ( 12 )\end{matrix}$$

The explanatory information EI is information regarding the explanatory variable associated to one or a plurality of coefficients included in at least one of the first linear combination LC1 and the second linear combination LC2. For example, in the case where the first linear combination LC1 and the second linear combination LC2 are expressed by the above-described the formulae (11) and (12), respectively, the explanatory information EI is information regarding the explanatory variable f associated to at least one of the coefficient a={a₁, a₂, . . . } and the coefficient c={c₁, c₂, . . . }. That is, the explanatory information EI may be expressed as information obtained by quantifying a correspondence relationship between the target variable y and the explanatory variable f relevant to the target variable y.

### (Communication Unit 16A)

The communication unit 16A is an interface for exchanging data via a network. Examples of the communication unit 16A include, but are not limited to, communication chips in various communication standards such as Ethernet (registered trademark), Wireless Fidelity (Wi-Fi) (registered trademark), and wireless communication standards of mobile data communication networks, and connectors compliant with a universal serial bus (USB).

### (Input/Output Unit 17A)

The input/output unit 17A is an interface for receiving a data input and outputting data. Examples of the input/output unit 17A include, but are not limited to, a microphone, a camera, a line-of-sight input device, a keyboard, a touch pad, a speaker, and a liquid crystal display.

### (Control Unit 10A)

The control unit 10A controls each component included in the information processing apparatus 1A. As illustrated in FIG. 4, the control unit 10A includes an acquisition unit 11, a designation unit 12, a derivation unit 13, and a generation unit 14. In the present example embodiment, the acquisition unit 11, the designation unit 12, the derivation unit 13, and the generation unit 14 implement an acquisition means, a designation means, a derivation means, and a generation means, respectively.

The acquisition unit 11 obtains data via the communication unit 16A or the input/output unit 17A. Examples of the data obtained by the acquisition unit 11 include the target data TD and information regarding the prior distribution of the hidden variable zₖ. The acquisition unit 11 stores the obtained data in the storage unit 15A.

The designation unit 12 designates, from the plurality of features included in the target data TD, one or a plurality of explanatory variables and one or a plurality of target variables. As an example, the designation unit 12 designates a feature x1 and a feature x2 included in the set of features (˜xk) as explanatory variables, and designates a feature y1 and a feature y2 included in the set of features (˜yk) as target variables. As another example, the designation unit 12 designates the sum of the feature x1 and the feature x2 included in the set of features (˜xk) as an explanatory variable. As still another example, a difference between the feature y1 and the feature y2 included in the set of features (˜yk) is designated as a target variable. The designation unit 12 may be expressed as a selection means for selecting the one or plurality of explanatory variables and one or plurality of target variables from the plurality of features included in the target data TD.

The derivation unit 13 derives the first linear combination LC1 and the second linear combination LC2. As an example, the derivation unit 13 trains a plurality of individual regression models associated with a plurality of individual ratio parameters RP defined by a hidden variable with reference to at least a part of the target data TD, and derives the first linear combination LC1 and the second linear combination LC2 using the plurality of regression models. As described above, in the present disclosure, the derivation unit 13 trains the two regression models with reference to at least a part of the target data TD.

As illustrated in FIG. 4, the derivation unit 13 includes a regression coefficient calculation unit 132, a covariance calculation unit 133, an internal division ratio parameter calculation unit 134, an output unit 135, an initial value determination unit 136, and a convergence determination unit 137. In the present example embodiment, the regression coefficient calculation unit 132, the covariance calculation unit 133, and the internal division ratio parameter calculation unit 134 implement a regression coefficient calculation means, a covariance calculation means, and a ratio parameter calculation means, respectively.

The regression coefficient calculation unit 132 calculates the regression coefficient RC for each of a plurality of target models with reference to the target data TD and the internal division ratio parameter RP that defines an internal division ratio of the plurality of target models. As an example, the internal division ratio parameter RP referred to by the regression coefficient calculation unit 132 is an initial value of the internal division ratio parameter RP determined by the initial value determination unit 136 to be described later. As another example, the internal division ratio parameter RP referred to by the regression coefficient calculation unit 132 is the internal division ratio parameter RP calculated by the internal division ratio parameter calculation unit 134 to be described later. The regression coefficient calculation unit 132 stores the calculated regression coefficient RC in the storage unit 15A. As described above, the internal division ratio parameter RP may be an external division ratio parameter. The internal division ratio parameter RP defines the internal division ratio of the two target models.

The covariance calculation unit 133 calculates the covariance parameter η of the prior distribution of the hidden variable zₖ and the covariance matrix Ψ of the posterior distribution of the hidden variable zₖ with reference to the target data TD, the internal division ratio parameter RP, the regression coefficient RC, and the covariance matrix Φ of the prior distribution of the hidden variable zₖ. The covariance calculation unit 133 stores, as the distribution information DI, the calculated covariance parameter η of the prior distribution of the hidden variable zₖ and covariance matrix Ψ of the posterior distribution of the hidden variable zₖ in the storage unit 15A.

The internal division ratio parameter calculation unit 134 calculates the internal division ratio parameter RP with reference to the target data TD, the regression coefficient RC, and the covariance matrix Ψ of the posterior distribution of the hidden variable zₖ. The internal division ratio parameter calculation unit 134 stores the calculated internal division ratio parameter RP in the storage unit 15A. The internal division ratio parameter calculation unit 134 may calculate an external division ratio parameter.

According to the configuration described above, the derivation unit 13 is enabled to suitably derive the first linear combination LC1 and the second linear combination LC2 using the L2PV regression model defined by the L2PV model described above.

The output unit 135 outputs data via the communication unit 16A and the input/output unit 17A. As an example, the output unit 135 outputs the first linear combination LC1 and the second linear combination LC2. As another example, the output unit 135 outputs the explanatory information EI.

The initial value determination unit 136 determines the initial value of the internal division ratio parameter RP referred to by the regression coefficient calculation unit 132. The initial value determination unit 136 stores the determined initial value of the internal division ratio parameter RP in the storage unit 15A.

The convergence determination unit 137 determines whether the calculation related to the internal division ratio parameter RP has converged. The convergence determination unit 137 supplies a determination result to the output unit 135.

The generation unit 14 generates the explanatory information EI. The generation unit 14 outputs the generated explanatory information EI. As an example, in a case where the one or plurality of target variables includes an index related to one or a plurality of tasks and the one or plurality of explanatory variables includes a feature related to a worker who performs the task, the generation unit 14 generates information regarding a skill level of the worker as the explanatory information EI.

It may also be expressed that the generation unit 14 refers to the one or plurality of coefficients included in at least one of the first linear combination LC1 of the one or plurality of explanatory variables, that is, the first linear combination LC1 that defines the upper limit of the target variable, and the second linear combination LC2 of the one or plurality of explanatory variables, that is, the second linear combination LC2 that defines the lower limit of the target variable, and generates the explanatory information EI regarding the explanatory variable relevant to the one or plurality of coefficients.

### (Configuration of Optimization Device 60)

A configuration of the optimization device 60 will be described with reference to FIG. 4 again. As illustrated in FIG. 4, the optimization device 60 includes a control unit 61 and a communication unit 62. The communication unit 62 has a function similar to that of the communication unit 16A described above, and thus descriptions thereof will be omitted.

The control unit 61 controls each component included in the optimization device 60. As illustrated in FIG. 4, the control unit 61 further includes an optimization unit 63. In the present example embodiment, the optimization unit 63 implements an optimization means.

The optimization unit 63 executes optimization processing with reference to at least a part of the target data TD under a constraint condition defined using at least one of the first linear combination LC1 and the second linear combination LC2.

The optimization unit 63 may execute the optimization processing with reference to at least a part of the target data TD under no constraint condition. In that case, if a combinatorial explosion occurs in the optimization processing (if no solution is obtained), the optimization unit 63 derives a constraint condition with reference to at least one of the first linear combination LC1 and the second linear combination LC2, and executes the optimization processing under the constraint condition.

### (First Exemplary Processing Flow of Information Processing Apparatus 1A)

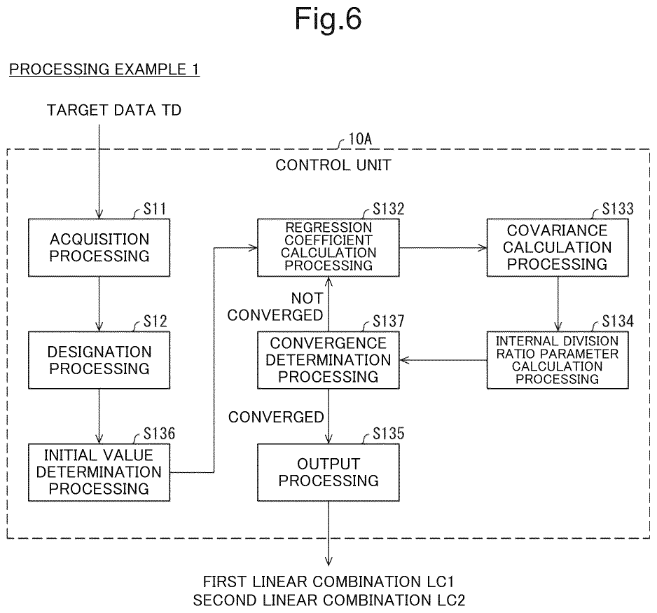

FIG. 6 is a diagram illustrating an exemplary processing flow of the information processing apparatus 1A according to the present example embodiment. While an exemplary process to be described below may be regarded as a variational Bayesian EM algorithm, this does not limit the present example embodiment. The exemplary process to be described below may also be regarded as a process of updating each parameter to maximize a variational lower bound (VLB) J obtained by the following formula (13).

$$\begin{matrix}[ Math . 13 ] & \\ J := {\sum }_{{z}_{1 : N}} q ( {z}_{1 : N} ) log \frac{p ( {\tilde{y}}_{1 : N} , {z}_{1 : N} \vert {\tilde{x}}_{1 : N} , W , η )}{q ( {z}_{1 : N} )} & ( 13 )\end{matrix}$$

The exemplary process to be described below may also be expressed as an algorithm for solving a maximum likelihood problem defined by the model likelihood p in the following formula (14).

$$\begin{matrix}[ Math . 14 ] & \\ p ( \tilde{y} \vert {z}_{k} , {\tilde{x}}_{k} , W , η ) = 𝒩 ( \tilde{y} \vert {\sum }_{i = 1}^{m} {z}_{k}^{( i )} {W}^{( i )} {\tilde{x}}_{k} , {η}^{- 1} {I}_{r} ) & ( 14 )\end{matrix}$$

### (Step S11: Acquisition Processing)

In step S11, the acquisition unit 11 obtains the target data TD. Here, as described above, the target data TD is data to be used for the training processing in the information processing apparatus 1A. The details of the target data TD have been described, and thus descriptions thereof will be omitted here.

In step S11, the acquisition unit 11 further obtains a parameter m indicating the number of models of the plurality of target models. Here, the number of models m is 2 as described above, which may be expressed as the number of internal division ratio parameter vectors μₖ⁽ⁱ⁾ as will be described later.

In step S11, the acquisition unit 11 further obtains the information regarding the prior distribution of the hidden variable zₖ. As an example, the acquisition unit 11 obtains the covariance matrix (D of the prior distribution p(zₖ) of the hidden variable zₖ. The acquisition unit 11 may further obtain the covariance parameter f of the prior distribution p(zₖ) of the hidden variable zₖ.

### (Step S12: Designation Processing)

In step S12, the designation unit 12 designates, from the plurality of features included in the target data TD, one or a plurality of explanatory variables and one or a plurality of target variables.

### (Step S136: Initial Value Determination Processing)

Subsequently, in step S136, the initial value determination unit 136 determines the initial value of the internal division ratio parameter RP to be referred to in regression coefficient calculation processing S132 to be described later. As an example, the initial value determination unit 136 determines the initial value of the internal division ratio parameter RP as a random value. The initial value determination unit 136 determines the initial value of the internal division ratio parameter RP in this manner, whereby the regression coefficient RC may be suitably calculated in the regression coefficient calculation processing S132 to be described later. The details of the internal division ratio parameter RP have been described, and thus descriptions thereof will be omitted here.

### (Step S132: Regression Coefficient Calculation Processing)

Subsequently, in step S132, the regression coefficient calculation unit 132 refers to the internal division ratio parameter (internal division ratio parameter vector) RP expressed by the following formula (15)

$$\begin{matrix}[ Math . 15 ] & \\ {\{ {μ}_{k} \}}_{k = 1}^{N} & ( 15 )\end{matrix}$$

and the target data TD expressed by the following formula (16)

$$\begin{matrix}[ Math . 16 ] & \\ {\{ {\tilde{x}}_{k} , {\tilde{y}}_{k} \}}_{k = 1}^{N} & ( 16 )\end{matrix}$$

and calculates the regression coefficient RC for each of the plurality of target models expressed by the following formula (17).

$$\begin{matrix}[ Math . 17 ] & \\ W = [ {W}^{( 1 )} , … , {W}^{( m )} ] & ( 17 )\end{matrix}$$

As an example, the regression coefficient calculation unit 132 refers to the internal division ratio parameter RP and the target data TD, and calculates the regression coefficient RC expressed by the following formula (19) based on the following formula (18).

$$\begin{matrix}[ Math . 18 ] & \\ {W}^{⋆} = \{ {\sum }_{k = 1}^{N} {\tilde{y}}_{k} ( {μ}_{k} ⊗ {\tilde{x}}_{k} ) \} {\{ {\sum }_{k = 1}^{N} ( {Ψ}_{k} + {μ}_{k} {μ}_{k}^{T} ) ⊗ {\tilde{x}}_{k} {\tilde{x}}_{k}^{T} \}}^{- 1} & ( 18 )\end{matrix}$$

$$\begin{matrix}[ Math . 19 ] & \\ W = {W}^{( 1 )} , … , {W}^{( m )} & ( 19 )\end{matrix}$$

Here, the asterisk attached to W indicates an updated value, and in the calculation formula, the operation symbol indicated by a cross in a circle represents a Kronecker product. T represents transposition. Ψₖ represents a covariance parameter of the posterior distribution of the hidden variable zₖ.

### (Step S133: Covariance Calculation Processing)

Subsequently, in step S133, the covariance calculation unit 133 refers to the target data TD expressed by the following formula (20),

$$\begin{matrix}[ Math . 20 ] & \\ {\{ {\tilde{x}}_{k} , {\tilde{y}}_{k} \}}_{k = 1}^{N} & ( 20 )\end{matrix}$$

the internal division ratio parameter (internal division ratio parameter vector) RP expressed by the following formula (21),

$$\begin{matrix}[ Math . 21 ] & \\ {\{ {μ}_{k} \}}_{k = 1}^{N} & ( 21 )\end{matrix}$$

the regression coefficient RC expressed by the following formula (22),

$$\begin{matrix}[ Math . 22 ] & \\ W = [ {W}^{( 1 )} , … , {W}^{( m )} ] & ( 22 )\end{matrix}$$

and the covariance matrix ψ of the prior distribution of the hidden variable zₖ, and calculates the covariance parameter η of the prior distribution of the hidden variable zₖ and a covariance matrix {Ψₖ}ₖ₌₁^{N} of the posterior distribution of the hidden variable zₖ. As an example, the covariance calculation unit 133 uses the following formula (23)

$$\begin{matrix}[ Math . 23 ] & \\ {Ψ}_{k}^{★} = {( η {Λ}_{k}^{T} {Λ}_{k} + {Φ}^{- 1} )}^{- 1} & ( 23 )\end{matrix}$$

(Here, Λₖ is given by the following formula (24))

$$\begin{matrix}[ Math . 24 ] & \\ {Λ}_{k} := [ {W}^{( 1 )} {\tilde{x}}_{k} , … , {W}^{( m )} {\tilde{x}}_{k} ] & ( 24 )\end{matrix}$$

to calculate the covariance matrix {Ψₖ}ₖ₌₁^{N} of the posterior distribution of the hidden variable zₖ. The covariance calculation unit 133 uses the following formula (25)

$$\begin{matrix}[ Math . 25 ] & \\ {η}^{★} = \frac{Nr}{{𝔼}_{q} [ {\sum }_{k = 1}^{N} {‖ {\tilde{y}}_{k} - W ( {z}_{k} ⊗ {\tilde{x}}_{k} ) ‖}^{2} ]} & ( 25 )\end{matrix}$$

to calculate the covariance parameter η of the prior distribution of the hidden variable zₖ. Here, N represents the number of samples of each state variable as described above, r represents a dimension of ˜yₖ, and for example, r=1.

### (Step S134: Internal Division Ratio Parameter Calculation Processing)

Subsequently, in step S134, the internal division ratio parameter calculation unit 134 refers to the following target data TD expressed by the following formula (26),

$$\begin{matrix}[ Math . 26 ] & \\ {\{ {\tilde{x}}_{k} , {\tilde{y}}_{k} \}}_{k - 1}^{N} & ( 26 )\end{matrix}$$

the regression coefficient RC expressed by the following formula (27),

$$\begin{matrix}[ Math . 27 ] & \\ W = [ {W}^{1} , … , {W}^{( m )} ] & ( 27 )\end{matrix}$$

and the covariance matrix {Ψₖ}ₖ₌₁^{N} of the posterior distribution of the hidden variable zₖ, and calculates (updates) the internal division ratio parameter (internal division ratio parameter vector) RP expressed by the following formula (28).

$$\begin{matrix}[ Math . 28 ] & \\ {\{ {μ}_{k} \}}_{k = 1}^{N} & ( 28 )\end{matrix}$$

As an example, the internal division ratio parameter calculation unit 134 executes processing of calculating k based on the following formula (29)

$$\begin{matrix}[ Math . 29 ] & \\ {μ}_{k}^{★} = {arg min}_{{μ}_{k}} \{ \frac{1}{2} {{μ}_{k}^{T} ( {Ψ}_{k}^{★} )}^{- 1} {μ}_{k} - ( η {\tilde{y}}_{k}^{T} {Λ}_{k} + \frac{1}{m} {1}_{m , 1} {Φ}^{- 1} ) {μ}_{k} \} & ( 29 )\end{matrix}$$

under a restraint condition (constraint condition) related to the sum of the internal division ratio parameter RP, thereby calculating (updating) the internal division ratio parameter RP. As an example, the internal division ratio parameter calculation unit 134 executes the processing of calculating k based on the following formula (30)

$$\begin{matrix}[ Math . 30 ] & \\ {μ}_{k}^{★} = {arg min}_{{μ}_{k}} \{ \frac{1}{2} {{μ}_{k}^{T} ( {Ψ}_{k}^{★} )}^{- 1} {μ}_{k} - ( η {\tilde{y}}_{k}^{T} {Λ}_{k} + \frac{1}{m} {1}_{m , 1} {Φ}^{- 1} ) {μ}_{k} \} & ( 30 )\end{matrix}$$

under a restraint condition (constraint condition) expressed by the following formula (31), thereby calculating the internal division ratio parameter (internal division ratio parameter vector) RP expressed by the following formula (32).

$$\begin{matrix}[ Math . 31 ] & \\ {1}_{m , 1}^{T} {μ}_{k} = 1 , {μ}_{k} ⪰ {0}_{m , 1} & ( 31 )\end{matrix}$$

$$\begin{matrix}[ Math . 32 ] & \\ {\{ {μ}_{k} \}}_{k = 1}^{N} & ( 32 )\end{matrix}$$

Here, the first formula of the restraint condition mentioned above may be expressed as Σᵢ₌₁^{m}μₖ⁽ⁱ⁾=1 if the index (i) related to the model is explicitly expressed. In other words, the first formula of the restraint condition mentioned above indicates that the sum of the internal division ratio parameters RP over the indexes related to the model is 1. The second formula of the restraint condition indicates that the value of the internal division ratio parameter RP is equal to or more than 0. As described above, by calculating the internal division ratio parameter RP under the restraint condition, the internal division ratio parameter calculation unit 134 is enabled to suitably calculate the internal division ratio parameter RP even if the normal distribution is adopted as the posterior distribution of the hidden variable as an example.

### (Step S137: Convergence Determination Processing)

Subsequently, in step S137, the convergence determination unit 137 determines whether the series of processing of steps S132, S133, and S134 described above has converged.

This may be expressed as determining whether the variational Bayesian EM algorithm described above has converged, or may be expressed as determining whether the calculation regarding the internal division ratio parameter RP in step S134 has converged. As an example, the convergence determination unit 137 refers to a value of the variational lower bound (VLB) J obtained by the following formula (33),

$$\begin{matrix}[ Math . 33 ] & \\ J := {\sum }_{{z}_{1 : N}} q ( {z}_{1 : N} ) log \frac{p ( {\tilde{y}}_{1 : N} , {z}_{1 : N} \vert {\tilde{x}}_{1 : N} , W , η )}{q ( {z}_{1 : N} )} & ( 33 )\end{matrix}$$

and determines that the series of processing of steps S132, S133, and S134 described above has converged if a variation of the variational lower bound is equal to or less than a predetermined threshold. For example, in the n-th convergence determination processing in the iteration of the series of processing of steps S132, S133, and S134 described above, the convergence determination unit 137 compares the (n−1)-th variational lower bound with the n-th variational lower bound, and if an absolute value of a difference therebetween is equal to or less than the predetermined threshold, it is determined that the series of processing of steps S132, S133, and S134 described above has converged.

Then, the process proceeds to output processing S135 if the convergence determination unit 137 determines that the processing has “converged”, whereas the process returns to the regression coefficient calculation processing S132 and the calculation of the regression coefficient RC is repeated if it is determined that the processing has “not converged”.

### (Step S135: Output Processing)

If the convergence determination unit 137 determines in step S137 that the processing has “converged”, in step S135, the output unit 135 outputs the first linear combination LC1 and the second linear combination LC2 specified by the regression coefficient RC expressed by the following formula (34),

$$\begin{matrix}[ Math . 34 ] & \\ W = [ {W}^{( 1 )} , … , {W}^{( m )} ] & ( 34 )\end{matrix}$$

which is calculated by the regression coefficient calculation unit 132 in step S132.

As described above, the output unit 135 outputs the first linear combination LC1 and the second linear combination LC2 in the case where the convergence determination unit 137 determines that the calculation regarding the internal division ratio parameter RP has “converged”, thereby being enabled to output the suitable first linear combination LC1 and second linear combination LC2.

In step S135, the output unit 135 may display graphs of the first linear combination LC1 and the second linear combination LC2 specified by the regression coefficient RC for the two target models in a manner of being distinguishable from each other.

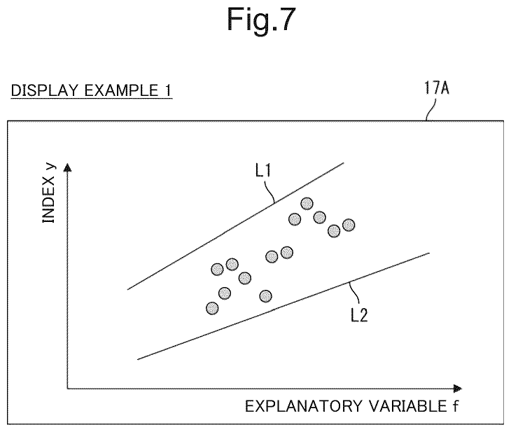

FIG. 7 illustrates an exemplary graph displayed by the output unit 135 via the input/output unit 17A in the present step. In the example illustrated in FIG. 7, in the regression coefficient calculation processing of step S132, the output unit 135 displays a graph L1 of the first linear combination LC1 specified by a regression coefficient W⁽¹⁾ of the model 1 and a graph L2 of the second linear combination LC2 specified by a regression coefficient W⁽²⁾ of the model 2 among the regression coefficients RC calculated for each of the two target models in a manner of being distinguishable from each other.

As described above, according to the information processing apparatus 1A according to the present example embodiment, the regression coefficient RC may be determined by training the internal division ratio parameter RP of each model while using the two models, whereby the output result including the upper limit of the target variable and the lower limit of the target variable (e.g., output result including the graph L1 and the graph L2 described above) may be generated.

### (Second Exemplary Processing Flow of Information Processing Apparatus 1A)

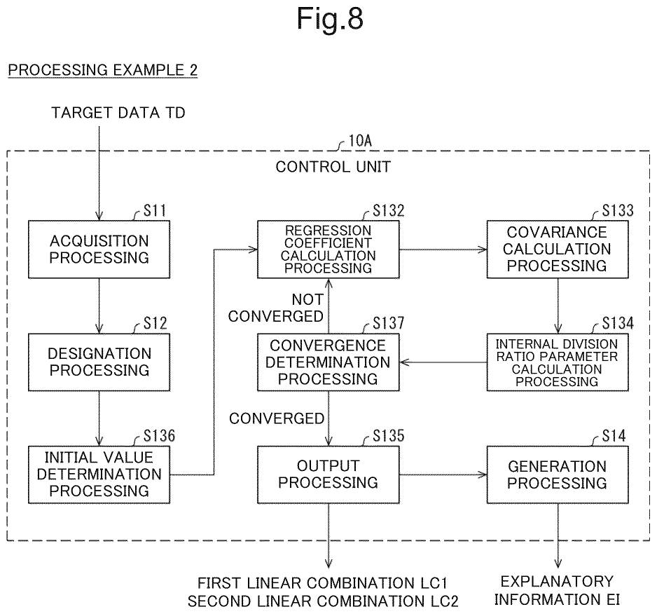

FIG. 8 is a diagram illustrating another exemplary processing flow of the information processing apparatus 1A according to the present example embodiment. The another exemplary processing flow of the information processing apparatus 1A will be described with reference to FIG. 8.

### (Steps S11 to S135)

The process from step S11 in which the acquisition unit 11 obtains the target data TD to step S135 in which the output unit 135 outputs the first linear combination LC1 and the second linear combination LC2 specified by the regression coefficient RC in the case where the convergence determination unit 137 determines that the processing has “converged” is the same as the process described above, and thus descriptions thereof will be omitted.

### (Step S14)

In step S14, the generation unit 14 refers to one or a plurality of coefficients included in at least one of the first linear combination LC1 and the second linear combination LC2, and generates the information regarding the explanatory variable associated to the one or plurality of coefficients.

For example, a case will be described in which the target variable is represented by y, the explanatory variable is represented by f={f₁, f₂, . . . }, and the first linear combination LC1 and the second linear combination LC2 are expressed by the following formulae (35) and (36).

$$\begin{matrix}[ Math . 35 ] & \\ y = {a}^{T} f + b & ( 35 )\end{matrix}$$

$$\begin{matrix}[ Math . 36 ] & \\ y = {c}^{T} f + d & ( 36 )\end{matrix}$$

In that case, the generation unit 14 generates, as the explanatory information EI, the information regarding the explanatory variable f associated to at least one of the coefficient a={a₁, a₂, . . . } and the coefficient c={c₁, c₂, . . . }.

As an example, an exemplary case will be described in which one or a plurality of target variables y includes an index related to one or a plurality of tasks and one or a plurality of explanatory variables f={f₁, f₂, . . . } includes a feature related to a worker who performs the task.

For example, it is assumed that the explanatory variable f₁ is an increase in working time in a case where an operator A₁ relevant to the coefficient a₁ is the worker who performs the task, and the explanatory variable f₂ is an increase in working time in a case where an operator A₂ relevant to the coefficient a₂ is the worker who performs the task. In other words, it is assumed that the working time increases by f₁ in the case where the operator A₁ works as a worker (the working time decreases by f₁ if the coefficient a₁ is negative), and the working time increases by f₂ in the case where the operator A₂ works as a worker (the working time decreases by f₂ if the coefficient a₂ is negative).

In that case, the coefficient a₁ and the coefficient a₂ represent the skill level of the operator A₁ and the operator A₂ with respect to the task, respectively. Thus, if the coefficient a is negative and an absolute value is larger than a predetermined value, the generation unit 14 generates the explanatory information EI indicating that the skill level of the operator relevant to the coefficient a is 3 (high skill level). Likewise, if the absolute value of the coefficient a is equal to or less than the predetermined value, the generation unit 14 generates the explanatory information EI indicating that the skill level of the operator relevant to the coefficient a is 2 (medium skill level). If the coefficient a is positive and the absolute value is larger than the predetermined value, the generation unit 14 generates the explanatory information EI indicating that the skill level of the operator relevant to the coefficient a is 1 (low skill level).

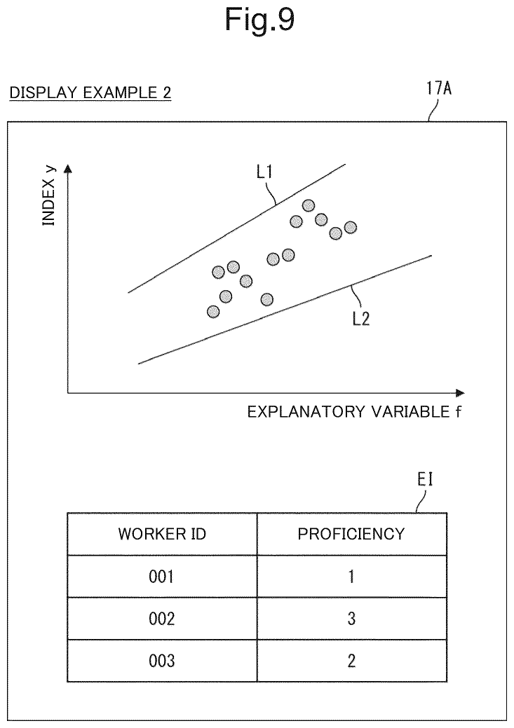

FIG. 9 is a diagram illustrating an example of the graph displayed by the output unit 135 via the input/output unit 17A in step S135 and the explanatory information EI displayed by the generation unit 14 via the input/output unit 17A in step S14. In the example illustrated in FIG. 9, in a similar manner to FIG. 7 described above, the output unit 135 displays the graph L1 of the first linear combination LC1 specified by the regression coefficient W⁽¹⁾ of the model 1 and the graph L2 of the second linear combination LC2 specified by the regression coefficient W⁽²⁾ of the model 2 among the regression coefficients RC in a manner of being distinguishable from each other. In the example of FIG. 9, the generation unit 14 displays, as the explanatory information EI, a table indicating that the skill level of the worker with worker ID “001” is “1”, the skill level of the worker with worker ID “002” is “3”, and the skill level of the worker with worker ID “003” is “2”.

As described above, according to the information processing apparatus 1A according to the present example embodiment, the explanatory information EI obtained by quantifying information that is difficult to quantify, such as a skill level, may be generated.

### (Exemplary Processing of Optimization Device 60)

The optimization unit 63 of the optimization device 60 obtains the first linear combination LC1 and the second linear combination LC2 output from the information processing apparatus 1A. Then, the optimization unit 63 executes the optimization processing with reference to at least a part of the target data TD.

For example, it is assumed that the target data TD is log data in which the worker A={A₁, A₂, . . . } performs the task X, the target variable y is the working time, the explanatory variable f={f₁, f₂, . . . } is the working time that increases in the case where the relevant worker A={A₁, A₂, . . . } performs the work, the first linear combination LC1 and the second linear combination LC2 are expressed by the following formulae (37) and (38), the first linear combination LC1 defines the upper limit of the working time of the task X, and the second linear combination LC2 defines the lower limit of the working time of the task X.

$$\begin{matrix}[ Math . 37 ] & \\ y = {a}^{T} f + b & ( 37 )\end{matrix}$$

$$\begin{matrix}[ Math . 38 ] & \\ y = {c}^{T} f + d & ( 38 )\end{matrix}$$

In that case, the optimization unit 63 optimizes a shift of the worker A={A₁, A₂, . . . }. The optimization unit 63 may optimize the shift of the worker A={A₁, A₂, . . . } with no constraint condition. If a combinatorial explosion occurs in the optimization processing (if no solution is obtained), the optimization unit 63 may derive a constraint condition defined using at least one of the first linear combination LC1 and the second linear combination LC2, and may execute the optimization processing under the constraint condition.

As described above, according to the optimization device 60 according to the present example embodiment, an optimization problem, such as shift optimization in business operations, may be solved, for example.

### (Effects of Information Processing Apparatus 1A)

As described above, in the information processing apparatus 1A, one or a plurality of explanatory variables and one or a plurality of target variables are designated from a plurality of features included in the target data TD, and the first linear combination LC1 of the one or plurality of explanatory variables, that is, the first linear combination LC1 that defines the upper limit of the target variable, and the second linear combination LC2 of the one or plurality of explanatory variables, that is, the second linear combination LC2 that defines the lower limit of the target variable, are derived.

With this configuration, even if the target data TD includes a plurality of features, the information processing apparatus 1A designates the explanatory variable and the target variable from the plurality of features, and derives the linear combination of the explanatory variable that defines the upper limit and the lower limit of the target variable. Thus, the information processing apparatus 1A is enabled to set appropriate upper and lower limits for the data including the plurality of features.

### Third Example Embodiment

A third example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### (Outline of Information Processing Apparatus 1B)

An information processing apparatus 1B includes a configuration of an optimization device 60 in addition to the configuration of the information processing apparatus 1A described above.

### (Configuration of Information Processing Apparatus 1B)

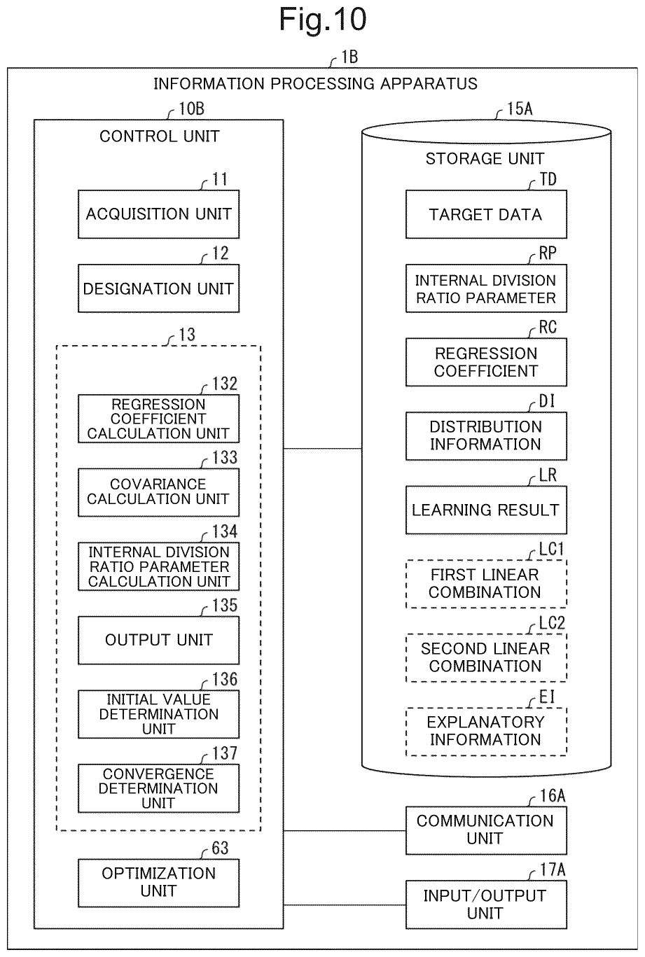

A configuration of the information processing apparatus 1B will be described with reference to FIG. 10. FIG. 10 is a block diagram illustrating the configuration of the information processing apparatus 1B. As illustrated in FIG. 10, the information processing apparatus 1B includes a control unit 10B, a storage unit 15A, a communication unit 16A, and an input/output unit 17A. The storage unit 15A, the communication unit 16A, and the input/output unit 17A are as described above.

The control unit 10B controls each component included in the information processing apparatus 1B. As illustrated in FIG. 10, the control unit 10B includes an acquisition unit 11, a designation unit 12, a derivation unit 13, and an optimization unit 63. In the present example embodiment, the acquisition unit 11, the designation unit 12, the derivation unit 13, and the optimization unit 63 implement an acquisition means, a designation means, a derivation means, and an optimization means, respectively. The acquisition unit 11, the designation unit 12, and the derivation unit 13 are as described above.

In a similar manner to the optimization unit 63 included in the optimization device 60 in the example embodiment described above, the optimization unit 63 executes optimization processing with reference to at least a part of target data TD under a constraint condition defined using at least one of a first linear combination LC1 and a second linear combination LC2.

### (Effects of Information Processing Apparatus 1B)

As described above, in the information processing apparatus 1B, one or a plurality of explanatory variables and one or a plurality of target variables are designated from a plurality of features included in the target data TD, and the first linear combination LC1 of the one or plurality of explanatory variables, that is, the first linear combination LC1 that defines an upper limit of the target variable, and the second linear combination LC2 of the one or plurality of explanatory variables, that is, the second linear combination LC2 that defines a lower limit of the target variable, are derived in a similar manner to the information processing apparatus 1A. Thus, in a similar manner to the information processing apparatus 1A, the information processing apparatus 1B is enabled to set appropriate upper and lower limits for the data including the plurality of features.

The information processing apparatus 1B includes the optimization unit 63. Thus, the information processing apparatus 1B may solve an optimization problem, such as shift optimization in business operations, for example.

### [Exemplary Implementation by Software]

Some or all of the functions of the information processing apparatuses 1, 1A, and 1B, the first information processing apparatus 1, the second information processing apparatus 2, and the optimization device 60 (which will also be described as “each of the above devices” hereinafter) may be implemented by hardware such as an integrated circuit (IC chip), or may be implemented by software.

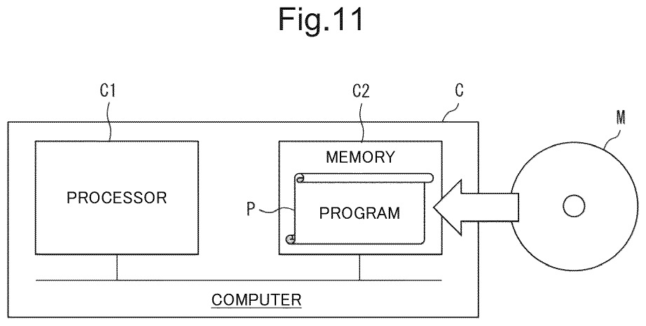

In the latter case, each of the above devices is implemented by, for example, a computer that executes a command of a program as software for implementing each function. An example of such a computer (which will be referred to as a computer C hereinafter) is illustrated in FIG. 11. FIG. 11 is a block diagram illustrating a hardware configuration of the computer C that functions as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes it, thereby implementing the functions of each of the above devices.

Examples of the processor C1 may include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 may include a flash memory, a hard disk drive (HDD), a solid state drive (SSD), and a combination thereof.

The computer C may further include a random access memory (RAM) for loading the program P at the time of execution and temporarily storing various types of data. The computer C may further include a communication interface for exchanging data with another device. The computer C may further include an input/output interface for connecting input/output devices such as a keyboard, a mouse, a display, a printer, and the like.

The program P may be recorded in a non-transitory tangible recording medium M readable by the computer C. Examples of such a recording medium M may include a tape, a disk, a card, a semiconductor memory, and a programmable logic circuit.

The computer C may obtain the program P via such a recording medium M. The program P may be transmitted via a transmission medium. Examples of such a transmission medium may include a communication network and a broadcast wave. The computer C may also obtain the program P via such a transmission medium.

Each of the above functions of each of the above devices may be implemented by a single processor provided in a single computer, may be implemented in cooperation with a plurality of processors provided in a single computer, or may be implemented in cooperation with a plurality of processors provided in each of a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information A

The present disclosure includes techniques described in the following Supplementary Notes. However, the present disclosure is not limited to the techniques described in the following Supplementary Notes, and various modifications may be made within the scope described in the claims.

### Supplementary Note A1

An information processing apparatus including:
an acquisition means for obtaining target data including a plurality of features;
a designation means for designating one or a plurality of explanatory variables and one or a plurality of target variables from the plurality of features included in the target data; and
a derivation means for deriving:
a first linear combination of the one or plurality of explanatory variables, the first linear combination defining an upper limit of the target variable; and
a second linear combination of the one or plurality of explanatory variables, the second linear combination defining a lower limit of the target variable.

### Supplementary Note A2

The information processing apparatus according to Supplementary Note A1, further including a generation means for referring to one or a plurality of coefficients included in at least one of the first linear combination or the second linear combination and generating information regarding the explanatory variable associated to the one or plurality of coefficients.

### Supplementary Note A3

The information processing apparatus according to Supplementary Note A2, in which
the one or plurality of target variables includes an index related to one or a plurality of tasks,
the one or plurality of explanatory variables includes a feature related to a worker who performs the task, and
the generation means generates information regarding proficiency of the worker as the information regarding the explanatory variable.

### Supplementary Note A4

The information processing apparatus according to any one of Supplementary Notes A1 to A3, further including an optimization means for executing optimization processing with reference to at least a part of the target data under a constraint condition defined using at least one of the first linear combination or the second linear combination.

### Supplementary Note A5

The information processing apparatus according to any one of Supplementary Notes A1 to A4, in which
the derivation means is configured to:
train a plurality of individual regression models associated with a plurality of individual ratio parameters defined by a hidden variable with reference to at least a part of the target data; and
derive the first linear combination and the second linear combination using the plurality of regression models.

### Supplementary Note A6

The information processing apparatus according to Supplementary Note A5, in which
the acquisition means further obtains information regarding a prior distribution of the hidden variable, and
the derivation means includes:
a regression coefficient calculation means for calculating a regression coefficient for each of the plurality of regression models with reference to the target data and the ratio parameters that define an internal division ratio of the plurality of regression models;
a covariance calculation means for calculating a covariance parameter of the prior distribution of the hidden variable and a covariance matrix of a posterior distribution of the hidden variable with reference to the target data, the ratio parameters, the regression coefficient, and the information regarding the prior distribution of the hidden variable; and
a ratio parameter calculation means for calculating the ratio parameters with reference to the target data, the regression coefficient, and the covariance matrix of the posterior distribution of the hidden variable.

### Supplementary Note A7

An information processing system including a first information processing apparatus and a second information processing apparatus, in which
the first information processing apparatus includes:
an acquisition means for obtaining target data including a plurality of features;
a selection means for selecting one or a plurality of explanatory variables and one or a plurality of target variables from the plurality of features included in the target data; and
a derivation means for deriving:
a first linear combination of the one or plurality of explanatory variables, the first linear combination defining an upper limit of the target variable; and
a second linear combination of the one or plurality of explanatory variables, the second linear combination defining a lower limit of the target variable, and
the second information processing apparatus includes:
an optimization means for executing optimization processing with reference to at least a part of the target data under a constraint condition defined using at least one of the first linear combination or the second linear combination.

### Supplementary Note A8

An information processing apparatus including:
an acquisition means for obtaining target data including a plurality of features;
a selection means for selecting one or a plurality of explanatory variables and one or a plurality of target variables from the plurality of features included in the target data; and
a generation means for referring to one or a plurality of coefficients included in at least one of a first linear combination of the one or plurality of explanatory variables, the first linear combination defining an upper limit of the target variable, or a second linear combination of the one or plurality of explanatory variables, the second linear combination defining a lower limit of the target variable, and generating information regarding the explanatory variable associated to the one or plurality of coefficients.

### Supplementary Note A9

The information processing apparatus according to Supplementary Note A8, in which
the one or plurality of target variables includes an index related to one or a plurality of tasks,
the one or plurality of explanatory variables includes a feature related to a worker who performs the task, and
the generation means generates information regarding proficiency of the worker as the information regarding the explanatory variable.

### Supplementary Information B

The present disclosure includes techniques described in the following Supplementary Notes. However, the present disclosure is not limited to the techniques described in the following Supplementary Notes, and various modifications may be made within the scope described in the claims.

### Supplementary Note B1

An information processing method including:
acquisition processing in which at least one processor obtains target data including a plurality of features;
designation processing in which the at least one processor designates one or a plurality of explanatory variables and one or a plurality of target variables from the plurality of features included in the target data; and
derivation processing in which the at least one processor derives
a first linear combination of the one or plurality of explanatory variables, the first linear combination defining an upper limit of the target variable, and
a second linear combination of the one or plurality of explanatory variables, the second linear combination defining a lower limit of the target variable.

### Supplementary Note B2

The information processing method according to Supplementary Note B1, further including generation processing in which the at least one processor refers to one or a plurality of coefficients included in at least one of the first linear combination or the second linear combination and generates information regarding the explanatory variable associated to the one or plurality of coefficients.

### Supplementary Note B3

The information processing method according to Supplementary Note B2, in which
the one or plurality of target variables includes an index related to one or a plurality of tasks,
the one or plurality of explanatory variables includes a feature related to a worker who performs the task, and
in the generation processing, the at least one processor generates information regarding proficiency of the worker as the information regarding the explanatory variable.

### Supplementary Note B4

The information processing method according to any one of Supplementary Notes B1 to B3, further including optimization processing in which the at least one processor executes optimization processing with reference to at least a part of the target data under a constraint condition defined using at least one of the first linear combination or the second linear combination.

### Supplementary Note B5

The information processing method according to any one of Supplementary Notes B1 to B4, in which
in the derivation processing, the at least one processor is further configured to:
train a plurality of individual regression models associated with a plurality of individual ratio parameters defined by a hidden variable with reference to at least a part of the target data; and
derive the first linear combination and the second linear combination using the plurality of regression models.

### Supplementary Note B6

The information processing method according to Supplementary Note B5, in which
in the acquisition processing, the at least one processor further obtains information regarding a prior distribution of the hidden variable, and
the derivation processing includes:
regression coefficient calculation processing for calculating a regression coefficient for each of the plurality of regression models with reference to the target data and the ratio parameters that define an internal division ratio of the plurality of regression models;
covariance calculation processing for calculating a covariance parameter of the prior distribution of the hidden variable and a covariance matrix of a posterior distribution of the hidden variable with reference to the target data, the ratio parameters, the regression coefficient, and the information regarding the prior distribution of the hidden variable; and
ratio parameter calculation processing for calculating the ratio parameters with reference to the target data, the regression coefficient, and the covariance matrix of the posterior distribution of the hidden variable.

### Supplementary Note B8

An information processing method including:
acquisition processing in which at least one processor obtains target data including a plurality of features;
selection processing in which the at least one processor selects one or a plurality of explanatory variables and one or a plurality of target variables from the plurality of features included in the target data; and
generation processing in which the at least one processor refers to one or a plurality of coefficients included in at least one of a first linear combination of the one or plurality of explanatory variables, the first linear combination defining an upper limit of the target variable, or a second linear combination of the one or plurality of explanatory variables, the second linear combination defining a lower limit of the target variable, and generates information regarding the explanatory variable associated to the one or plurality of coefficients.

### Supplementary Note B9

The information processing method according to Supplementary Note B8, in which
the one or plurality of target variables includes an index related to one or a plurality of tasks,
the one or plurality of explanatory variables includes a feature related to a worker who performs the task, and
in the generation processing, the at least one processor generates information regarding proficiency of the worker as the information regarding the explanatory variable.

### Supplementary Information C

The present disclosure includes techniques described in the following Supplementary Notes. However, the present disclosure is not limited to the techniques described in the following Supplementary Notes, and various modifications may be made within the scope described in the claims.

### Supplementary Note C1

An information processing program for causing a computer to function as an information processing apparatus, the program causing the computer to implement a function including:
an acquisition means for obtaining target data including a plurality of features;
a designation means for designating one or a plurality of explanatory variables and one or a plurality of target variables from the plurality of features included in the target data; and
a derivation means for deriving:
a first linear combination of the one or plurality of explanatory variables, the first linear combination defining an upper limit of the target variable; and
a second linear combination of the one or plurality of explanatory variables, the second linear combination defining a lower limit of the target variable.

### Supplementary Note C2

The information processing program according to Supplementary Note C1, the program causing the computer to implement the function further including:
a generation means for referring to one or a plurality of coefficients included in at least one of the first linear combination or the second linear combination and generating information regarding the explanatory variable associated to the one or plurality of coefficients.

### Supplementary Note C3

The information processing program according to Supplementary Note C2, in which
the one or plurality of target variables includes an index related to one or a plurality of tasks,
the one or plurality of explanatory variables includes a feature related to a worker who performs the task, and
the generation means generates information regarding proficiency of the worker as the information regarding the explanatory variable.

### Supplementary Note C4

The information processing program according to any one of Supplementary Notes C1 to C3, the program causing the computer to implement the function further including:
an optimization means for executing optimization processing with reference to at least a part of the target data under a constraint condition defined using at least one of the first linear combination or the second linear combination.

### Supplementary Note C5

The information processing program according to any one of Supplementary Notes C1 to C4, in which
the derivation means is configured to:
train a plurality of individual regression models associated with a plurality of individual ratio parameters defined by a hidden variable with reference to at least a part of the target data; and
derive the first linear combination and the second linear combination using the plurality of regression models.

### Supplementary Note C6

The information processing program according to Supplementary Note C5, in which
the acquisition means further obtains information regarding a prior distribution of the hidden variable, and
the derivation means includes:
a regression coefficient calculation means for calculating a regression coefficient for each of the plurality of regression models with reference to the target data and the ratio parameters that define an internal division ratio of the plurality of regression models;
a covariance calculation means for calculating a covariance parameter of the prior distribution of the hidden variable and a covariance matrix of a posterior distribution of the hidden variable with reference to the target data, the ratio parameters, the regression coefficient, and the information regarding the prior distribution of the hidden variable; and
a ratio parameter calculation means for calculating the ratio parameters with reference to the target data, the regression coefficient, and the covariance matrix of the posterior distribution of the hidden variable.

### Supplementary Note C7

An information processing program for causing a computer to function as an information processing system, the program causing the computer to implement a function including:
an acquisition means for obtaining target data including a plurality of features;
a selection means for selecting one or a plurality of explanatory variables and one or a plurality of target variables from the plurality of features included in the target data;
a derivation means for deriving:
a first linear combination of the one or plurality of explanatory variables, the first linear combination defining an upper limit of the target variable; and
a second linear combination of the one or plurality of explanatory variables, the second linear combination defining a lower limit of the target variable; and
an optimization means for executing optimization processing with reference to at least a part of the target data under a constraint condition defined using at least one of the first linear combination or the second linear combination.

### Supplementary Note C8

An information processing program for causing a computer to function as an information processing apparatus, the program causing the computer to implement a function including:
an acquisition means for obtaining target data including a plurality of features;
a selection means for selecting one or a plurality of explanatory variables and one or a plurality of target variables from the plurality of features included in the target data; and
a generation means for referring to one or a plurality of coefficients included in at least one of a first linear combination of the one or plurality of explanatory variables, the first linear combination defining an upper limit of the target variable, or a second linear combination of the one or plurality of explanatory variables, the second linear combination defining a lower limit of the target variable, and generating information regarding the explanatory variable associated to the one or plurality of coefficients.

### Supplementary Note C9

The information processing program according to Supplementary Note C8, in which
the one or plurality of target variables includes an index related to one or a plurality of tasks,
the one or plurality of explanatory variables includes a feature related to a worker who performs the task, and
the generation means generates information regarding proficiency of the worker as the information regarding the explanatory variable.

### Supplementary Information D

The present disclosure includes techniques described in the following Supplementary Notes. However, the present disclosure is not limited to the techniques described in the following Supplementary Notes, and various modifications may be made within the scope described in the claims.

### Supplementary Note D1

An information processing apparatus including at least one processor, in which
the at least one processor performs a process including:
acquisition processing for obtaining target data including a plurality of features;
designation processing for designating one or a plurality of explanatory variables and one or a plurality of target variables from the plurality of features included in the target data; and
derivation processing for deriving:
a first linear combination of the one or plurality of explanatory variables, the first linear combination defining an upper limit of the target variable; and
a second linear combination of the one or plurality of explanatory variables, the second linear combination defining a lower limit of the target variable.

The information processing apparatus may further include a memory. The memory may store a program for causing the at least one processor to execute each of the processing.

### Supplementary Note D2

The information processing apparatus according to Supplementary Note D1, in which
the at least one processor performs the process further including:
generation processing for referring to one or a plurality of coefficients included in at least one of the first linear combination or the second linear combination and generating information regarding the explanatory variable associated to the one or plurality of coefficients.

### Supplementary Note D3

The information processing apparatus according to Supplementary Note D2, in which
the one or plurality of target variables includes an index related to one or a plurality of tasks,
the one or plurality of explanatory variables includes a feature related to a worker who performs the task, and
in the generation processing, the at least one processor generates information regarding proficiency of the worker as the information regarding the explanatory variable.

### Supplementary Note D4

The information processing apparatus according to any one of Supplementary Notes D1 to D3, in which the at least one processor performs the process further including optimization processing for executing optimization processing with reference to at least a part of the target data under a constraint condition defined using at least one of the first linear combination or the second linear combination.

### Supplementary Note D5

The information processing apparatus according to any one of Supplementary Notes D1 to D4, in which
in the derivation processing, the at least one processor is further configured to:
train a plurality of individual regression models associated with a plurality of individual ratio parameters defined by a hidden variable with reference to at least a part of the target data; and
derive the first linear combination and the second linear combination using the plurality of regression models.

### Supplementary Note D6

The information processing apparatus according to Supplementary Note D5, in which
in the acquisition processing, the at least one processor further obtains information regarding a prior distribution of the hidden variable, and
in the derivation processing, the at least one processor is configured to execute:
regression coefficient calculation processing for calculating a regression coefficient for each of the plurality of regression models with reference to the target data and the ratio parameters that define an internal division ratio of the plurality of regression models;
covariance calculation processing for calculating a covariance parameter of the prior distribution of the hidden variable and a covariance matrix of a posterior distribution of the hidden variable with reference to the target data, the ratio parameters, the regression coefficient, and the information regarding the prior distribution of the hidden variable; and
ratio parameter calculation processing for calculating the ratio parameters with reference to the target data, the regression coefficient, and the covariance matrix of the posterior distribution of the hidden variable.

### Supplementary Note D7

An information processing system including a first information processing apparatus and a second information processing apparatus, in which
at least one processor included in the first information processing apparatus performs a process including:
acquisition processing for obtaining target data including a plurality of features;
selection processing for selecting one or a plurality of explanatory variables and one or a plurality of target variables from the plurality of features included in the target data; and
derivation processing for deriving:
a first linear combination of the one or plurality of explanatory variables, the first linear combination defining an upper limit of the target variable; and
a second linear combination of the one or plurality of explanatory variables, the second linear combination defining a lower limit of the target variable, and
at least one processor included in the second information processing apparatus performs a process including:
optimization processing for executing optimization processing with reference to at least a part of the target data under a constraint condition defined using at least one of the first linear combination or the second linear combination.

### Supplementary Note D8

An information processing apparatus including at least one processor, in which
the at least one processor performs a process including:
acquisition processing for obtaining target data including a plurality of features;
selection processing for selecting one or a plurality of explanatory variables and one or a plurality of target variables from the plurality of features included in the target data; and
generation processing for referring to one or a plurality of coefficients included in at least one of a first linear combination of the one or plurality of explanatory variables, the first linear combination defining an upper limit of the target variable, or a second linear combination of the one or plurality of explanatory variables, the second linear combination defining a lower limit of the target variable, and generating information regarding the explanatory variable associated to the one or plurality of coefficients.

The information processing apparatus may further include a memory. The memory may store a program for causing the at least one processor to execute each of the processing.

### Supplementary Note D9

The information processing apparatus according to Supplementary Note D8, in which
the one or plurality of target variables includes an index related to one or a plurality of tasks,
the one or plurality of explanatory variables includes a feature related to a worker who performs the task, and
in the generation processing, the at least one processor generates information regarding proficiency of the worker as the information regarding the explanatory variable.

### Supplementary Information E

The present disclosure includes techniques described in the following Supplementary Notes. However, the present disclosure is not limited to the techniques described in the following Supplementary Notes, and various modifications may be made within the scope described in the claims.

### Supplementary Note E1

A non-transitory recording medium recording an information processing program for causing a computer to function as an information processing apparatus, the program causing the computer to perform a process including:
acquisition processing for obtaining target data including a plurality of features;
designation processing for designating one or a plurality of explanatory variables and one or a plurality of target variables from the plurality of features included in the target data; and
derivation processing for deriving:
a first linear combination of the one or plurality of explanatory variables, the first linear combination defining an upper limit of the target variable; and
a second linear combination of the one or plurality of explanatory variables, the second linear combination defining a lower limit of the target variable.

### Supplementary Note E2

A non-transitory recording medium recording an information processing program for causing a computer to function as an information processing apparatus, the program causing the computer to perform a process including:
acquisition processing for obtaining target data including a plurality of features;
selection processing for selecting one or a plurality of explanatory variables and one or a plurality of target variables from the plurality of features included in the target data; and
generation processing for referring to one or a plurality of coefficients included in at least one of a first linear combination of the one or plurality of explanatory variables, the first linear combination defining an upper limit of the target variable, or a second linear combination of the one or plurality of explanatory variables, the second linear combination defining a lower limit of the target variable, and generating information regarding the explanatory variable associated to the one or plurality of coefficients.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing apparatus comprising:
one or more memories storing instructions; and
one or more processors configured to execute the instructions to:
obtain target data including a plurality of features;
designate one or a plurality of explanatory variables and one or a plurality of target variables from the plurality of features included in the target data;
derive a first linear combination of the one or plurality of explanatory variables, the first linear combination defining an upper limit of the one or a plurality of target variables; and
derive a second linear combination of the one or plurality of explanatory variables, the second linear combination defining a lower limit of the one or a plurality of target variables.

2. The information processing apparatus according to claim 1, wherein
the one or more processors are further configured to execute the instructions to refer to one or a plurality of coefficients included in at least one of the first linear combination or the second linear combination and generate information regarding the explanatory variable associated with the one or plurality of coefficients.

3. The information processing apparatus according to claim 2, wherein
the one or plurality of target variables include an index related to one or a plurality of tasks,
the one or plurality of explanatory variables include a feature related to a worker who performs the task, and
the one or more processors are further configured to execute the instructions to generate information regarding proficiency of the worker as the information regarding the explanatory variable.

4. The information processing apparatus according to claim 1, wherein
the one or more processors are further configured to execute the instructions to execute optimization processing with reference to at least a part of the target data under a constraint condition defined using at least one of the first linear combination or the second linear combination.

5. The information processing apparatus according to claim 1, wherein
the one or more processors are configured to execute the instructions to:
train, with reference to at least a part of the target data, a plurality of individual regression models associated with a plurality of individual ratio parameters defined by a hidden variable; and
derive the first linear combination and the second linear combination using the plurality of regression models.

6. The information processing apparatus according to claim 5, wherein
the one or more processors are further configured to execute the instructions to:
obtain information regarding a prior distribution of the hidden variable;
calculate a regression coefficient for each of the plurality of regression models with reference to the target data and the ratio parameters, the ratio parameters defining an internal division ratio of the plurality of regression models;
calculate a covariance parameter of the prior distribution of the hidden variable and a covariance matrix of a posterior distribution of the hidden variable with reference to the target data, the ratio parameters, the regression coefficient, and the information regarding the prior distribution of the hidden variable; and
calculate the ratio parameters with reference to the target data, the regression coefficient, and the covariance matrix of the posterior distribution of the hidden variable.

7. An information processing method comprising:
by a computer,
obtaining target data including a plurality of features;
designating one or a plurality of explanatory variables and one or a plurality of target variables from the plurality of features included in the target data; and
deriving a first linear combination of the one or plurality of explanatory variables, the first linear combination defining an upper limit of the one or a plurality of target variables, and
deriving a second linear combination of the one or plurality of explanatory variables, the second linear combination defining a lower limit of the one or a plurality of target variables.

8. A non-transitory recording medium recording a program for causing a computer to execute:
obtaining target data including a plurality of features;
designating one or a plurality of explanatory variables and one or a plurality of target variables from the plurality of features included in the target data;
deriving a first linear combination of the one or plurality of explanatory variables, the first linear combination defining an upper limit of the one or a plurality of target variables; and
deriving a second linear combination of the one or plurality of explanatory variables, the second linear combination defining a lower limit of the one or a plurality of target variables.

9. The information processing apparatus according to claim 1, wherein
the one or more processors are further configured to execute the instructions to:
train, by a machine learning algorithm, a plurality of regression models based on at least a part of the target data; and
derive the first linear combination and the second linear combination using the plurality of trained regression models.

10. The information processing apparatus according to claim 1, wherein
the one or more processors are further configured to execute the instructions to perform an optimization process using, as a constraint, at least one of the first linear combination or the second linear combination to generate information for supporting a user's decision making regarding business optimization.
